(19) United States
(12) Patent Application Publication
(10) Pub. No.: US 2011/0072768 A1
(43) Pub. Date: Mar. 31, 2011

(54) CLIMATE CONTROLLED SEAT PAD FOR USE WITH A SADDLE

(75) Inventors: Karl U. Wuerminghausen, Canton, OH (US); Nadja Kotitschke, Canton, OH (US)

(73) Assignee: COZYRIDES LLC, Canton, OH (US)

(21) Appl. No.: 12/892,517

(22) Filed: Sep. 28, 2010

Related U.S. Application Data
(60) Provisional application No. 61/247,166, filed on Sep. 30, 2009.

(51) Int. Cl. B68C 1/02

(52) U.S. Cl. 54/44.5

(57) ABSTRACT

A seat pad including a top layer having a front end and a back end, a bottom layer having a front end and a back end, a cavity defined by the top layer and the bottom layer, a climate controlled thermal pad disposed within the cavity, a first attachment system secured proximate the bottom layer back end for containing a saddle cantle, and a second attachment system secured proximate the bottom layer front end for containing a saddle pommel. The thermal pad is activatable to either heat or cool the top layer of the seat pad.

### CROSS REFERENCE TO RELATED APPLICATIONS

This application claims priority from U.S. Provisional Application Ser. No. 61/247,166 filed on Sep. 30, 2009, the entire disclosure of which is incorporated herein by reference.

### BACKGROUND OF THE INVENTION

1. Technical Field

The invention relates generally to a seat pad for equine riders. More particularly, the invention relates to a seat pad that is used on a saddle. Specifically, the invention relates to a climate controlled seat pad which can be secured to a variety of different types of saddles and is used to maintain a comfortable temperature for the rider.

2. Background Information

Equine riders generally have two choices when riding a horse. The rider may utilize a saddle or ride the horse bareback. Riding bareback is a much more difficult task than utilizing a saddle because the rider is forced to maintain balance without any additional assistance. A saddle, on the other hand, allows the rider a more comfortable and contoured seating surface to help assist the rider in maintaining his or her balance.

A saddle is a supportive structure for a rider that is fastened around the animal's body by a girth. Saddles have been used for hundreds of years to ride horses and other large animals. Modern saddles generally fit into two categories, the English saddle and the Western saddle.

The English saddle generally consists of a seat, a pommel, a cantle and stirrups. The seat is the central portion of the saddle where the rider sits and is usually positioned lower than the pommel and cantle to provide stability. The pommel is the front portion of the saddle and is generally curved upwardly. The cantle is the back portion of the saddle and also curves upwardly. The pommel and cantle thus aid in creating the contoured seat for the rider. The English saddle provides additional support for the rider with the contoured seat between the pommel and the cantle. However, the rider does not have something secure to hold on to. Thus, an English saddle is generally used by a more advanced rider.

The Western saddle, also known as a Stock saddle, includes the same basic components as the English saddle, namely, a seat, a pommel, a cantle, and stirrups. The Western saddle, however, also includes a horn that extends outwardly and upwardly from the pommel and terminates in a knob. Advantageously, the horn and knob provide the rider with a place to tie rope, secure goods and to hold onto while riding. The saddle therefore gives the rider a greater sense of security when seated thereon. Additionally, the angles of the cantle and pommel of the Western saddle relative to the seat are generally more severe and thereby provide greater support and a more curved seat area for the rider. Examples of other types of Stock saddles include the Australian Stock saddle and the side saddle, both of which are similar in design to the Western saddle.

As indicated previously, a saddle rests on the back of the horse and is secured with a girth or cinch which goes under the horse's barrel. A saddle blanket may be located between the horse's back and the bottom surface of the saddle. The blanket aids in absorbing sweat from the horse's body and provides cushioning to protect the horse's back. While the saddle blanket provides some padding for the saddle, the rider's comfort is generally limited to the padding incorporated in the saddle body itself. Some saddles are designed with padding beneath a leather exterior cover to provide the rider with all day comfort.

There remains a need in the art for providing an even more comfortable saddle for riders.

### BRIEF SUMMARY OF THE INVENTION

The present invention broadly comprises a seat pad that is positioned on a top surface of a saddle. The seat pad includes a top layer having a front end and a back end, a bottom layer having a front end and a back end, a cavity defined between the top layer and the bottom layers, a climate control pad or thermal pad disposed within the cavity, a first attachment system for securing the back end of the seat pad to the saddle, and a second attachment system for securing the front end of the seat pad to the saddle. More specifically, the first attachment system secures the back end of the seat pad to the cantle and the second attachment system secures the front end of the seat pad to the front end of the saddle, most specifically to the pommel or horn of the saddle.

The present invention also broadly comprises a seat pad including a top layer having a front end and a back end, a bottom layer having a front end and a back end, a cavity defined between the top layer and the bottom layer, a padding disposed within the cavity, a climate control pad or thermal pad secured on the padding and within the cavity, a first attachment system for securing the back end of the seat pad to the back end of a saddle and a second attachment system for securing the front end of the seat pad to the front end of the saddle. The seat pad also includes a power source and controls for regulating the temperature of the thermal pads.

### BRIEF DESCRIPTION OF THE SEVERAL VIEWS OF THE DRAWINGS

A preferred embodiment of the present invention illustrative of the best mode(s) in which the Applicant(s) contemplate applying the principles of the present invention, is set forth in the following description and is shown in the drawings and is particularly and distinctly pointed out and set forth in the appended claims.

FIG. 1 is a side elevational view of a saddle positioned on a region of a horse's back with a first preferred embodiment of a seat pad in accordance with the present invention disposed on a top surface of the saddle seat;

FIG. 2 is an enlarged view of the section labeled FIG. 2 in FIG. 1 and particularly illustrating a first attachment system that engages the cantle of the saddle;

FIG. 3 is an enlarged view of the portion labeled FIG. 3 in FIG. 1 and particularly illustrating a second attachment system that engages the pommel of the saddle and, more specifically, the saddle horn;

FIG. 4 is a bottom view of the seat pad with portions of a battery pouch removed;

FIG. 5 is a bottom view of the seat pad with portions of the bottom layer thereof removed to illustrate a plurality of thermal pads disposed in the interior cavity;

FIG. 6 is a side elevational view of the seat pad with the top layer, the bottom layer, the first attachment system and the second attachment system shown in dashed lines and illustrating the thermal pad system contained within the interior cavity of the pad;

FIG. 7 is a side elevational view of a first preferred embodiment seat pad being lowered onto a seat of a saddle;

FIG. 8 is a top plan view with portions of the top layer removed to show the thermal pads and padding of a second preferred embodiment of a seat pad in accordance with the present invention;

FIG. 9 is a side elevational view of the seat pad of FIG. 9, with the top layer, the bottom layer, the first attachment system and the second attachment system shown in dashed lines and illustrating the second preferred embodiment pad and padding arrangement;

FIG. 10 is a bottom plan view of a third preferred embodiment seat pad illustrating a zipper to provide access inside the seat pad;

FIG. 11 is a top plan view of a third preferred embodiment of a seat pad in accordance with the present invention with portions of the top layer removed to illustrate the thermal pad system contained therein;

FIG. 12 is a side elevational view of the seat pad of FIG. 11, with the top layer, the bottom layer, the first attachment system and the second attachment system shown in dashed lines and showing the thermal pads disposed within the cavity;

FIG. 13 is a bottom plan view of a fourth preferred embodiment of a seat pad in accordance with the present invention, illustrating a snap connection for the second attachment system; and

FIG. 14 is a fifth preferred embodiment of a seat pad in accordance with the present invention illustrating a hook-and-loop-type of second attachment system.

### DESCRIPTION OF THE PREFERRED EMBODIMENTS

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed aspects of the invention.

Unless defined otherwise, all technical and scientific terms used herein have the same meaning as commonly understood to one of ordinary skill in the art to which this invention pertains. Although any methods, devices or materials similar or equivalent to those described herein can be used in the practice or testing of the invention, the preferred methods, devices, and materials are now described.

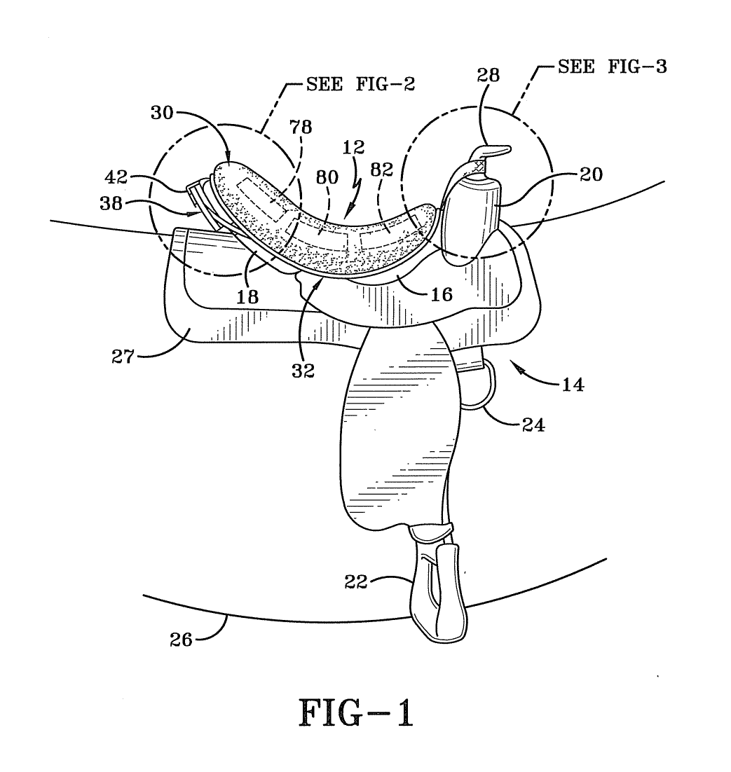

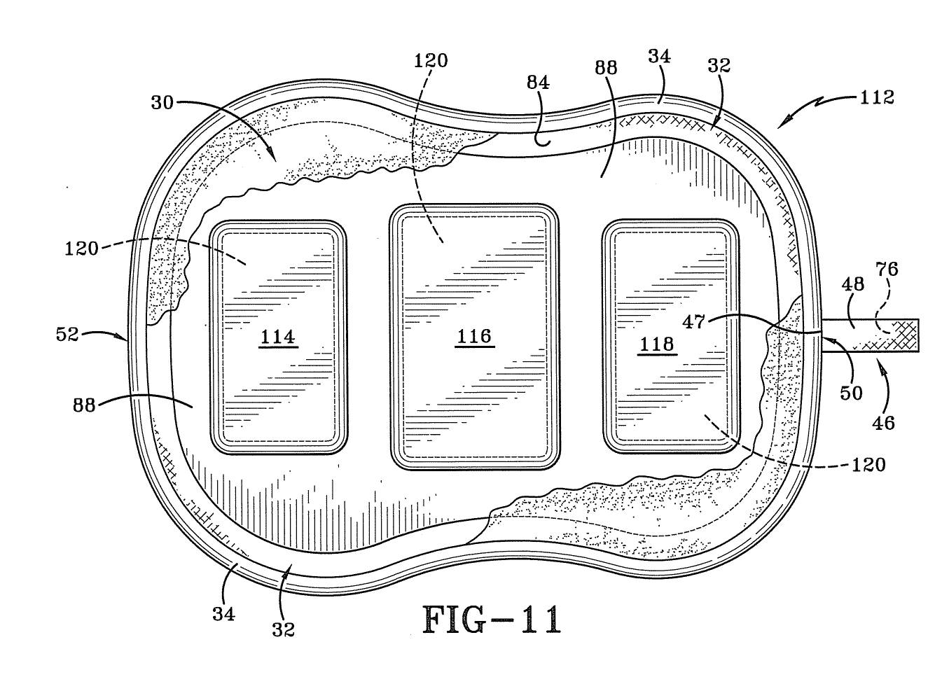

A climate controlled seat pad in accordance with the present invention is shown in FIGS. 1 through 14 and is generally indicated herein by the reference character 12. As specifically shown in FIG. 1, seat pad 12 positioned atop of a saddle 14. Saddle 14 includes a seat 16, a cantle 18 and a pommel 20. Saddle 14 further includes stirrups 22 and a buckle ring 24 for receiving a girdle (not shown) therein for securing saddle 14 to the back of a horse 26. A blanket 27 preferably is positioned between saddle 14 and the back of horse 26. Seat pad 12 is contemplated to be positioned on seat 16 and to be secured to cantle 18 at one end and to pommel 20 at the other end.

Seat pad 12 is shown in FIGS. 1 through 14 as being placed on a Western saddle 14. The Western saddle 14 also includes a horn 28 formed on and extending outwardly from pommel 20 of the saddle. It will be understood by those skilled in the art that seat pad 12 may be used in conjunction with any other style of saddle including but not limited to an English saddle, an Australian Stock saddle and a side saddle.

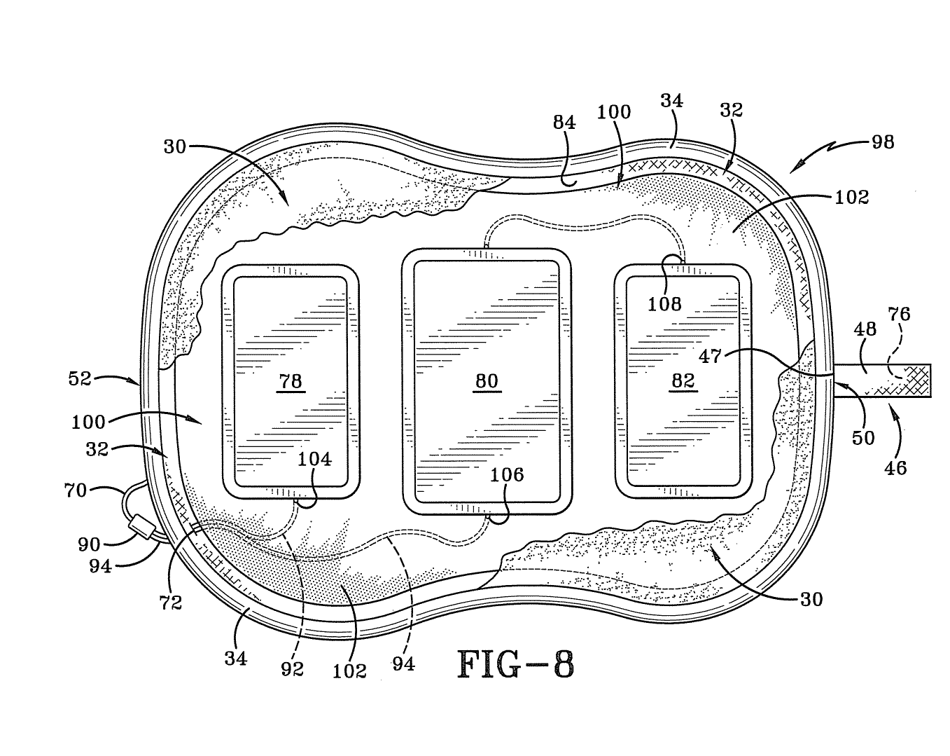

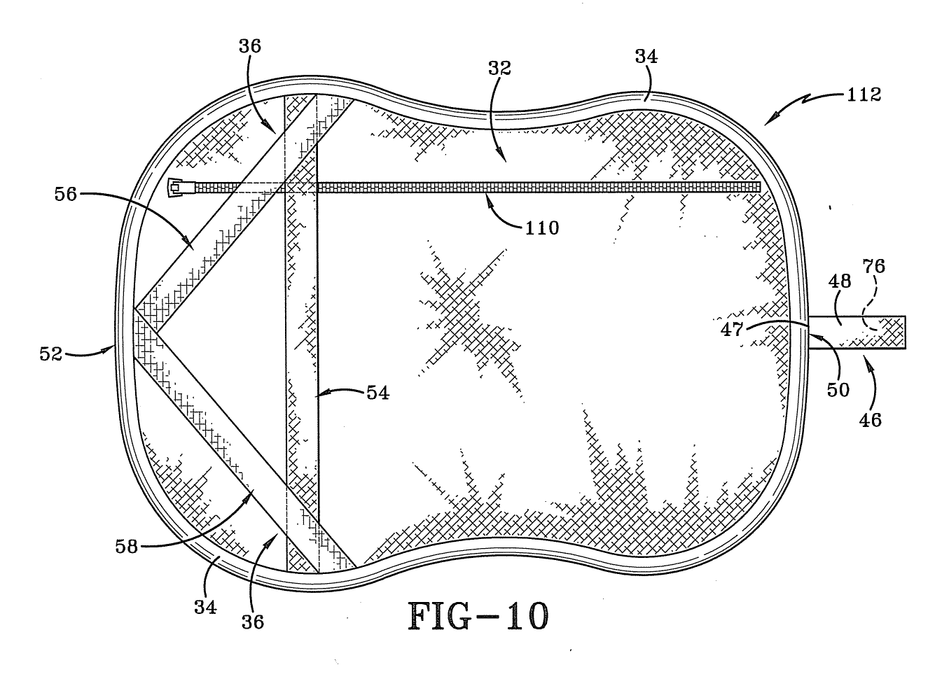

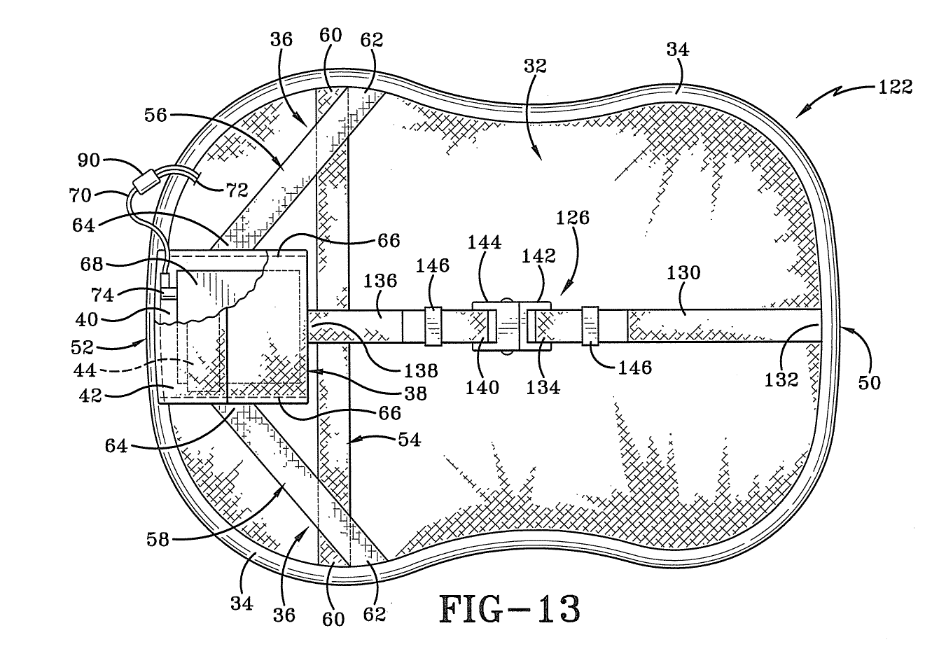

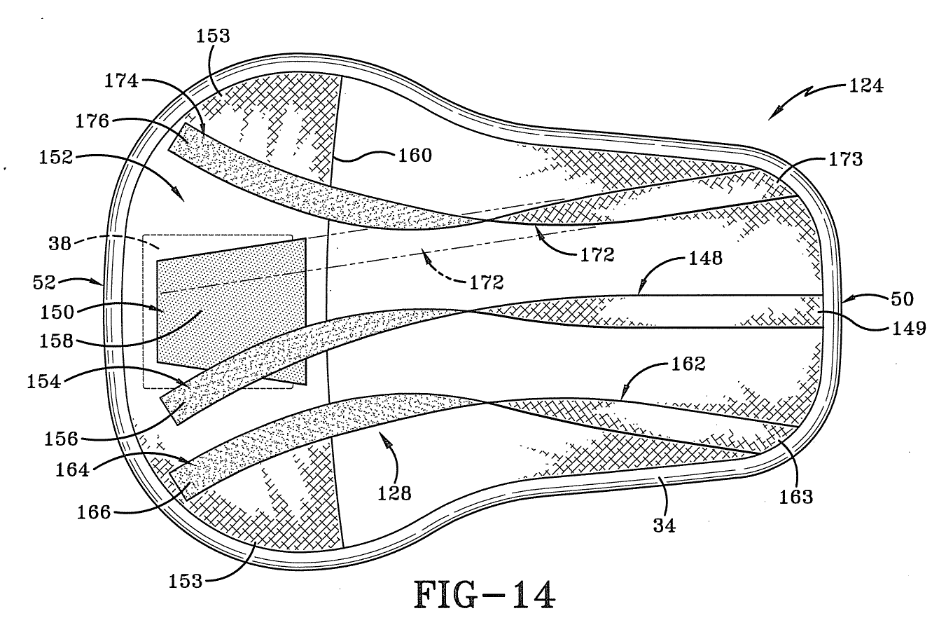

FIGS. 1 through 7 specifically show a first preferred embodiment of the climate controlled seat pad 12 in accordance with the present invention that is secured to the cantle 18 and horn 28 of a Western style saddle 14. FIGS. 8 and 9 show a second preferred embodiment of the climate controlled seat pad 98 that includes additional padding in its interior. FIGS. 10 through 12 show a third preferred embodiment of the climate controlled seat pad 112 which includes an alternative type of thermal pad disposed therein. FIG. 13 shows a fourth preferred embodiment of the climate controlled seat pad 122 which includes an alternative type of attachment system useful for securing seat pad 122 to an English style saddle. Finally, FIG. 14 shows a fifth preferred embodiment of the climate controlled seat pad 124 that shows yet another type of attachment system that is useful for securing seat pad 124 to an English style saddle.

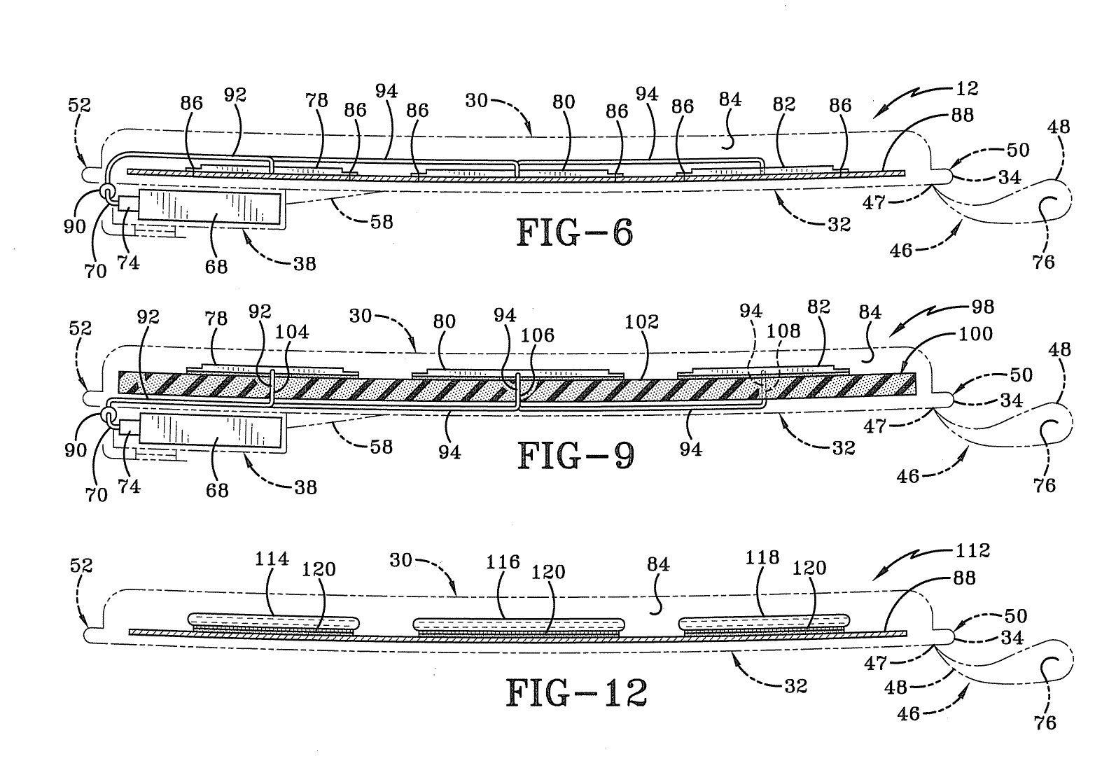

As shown in FIGS. 1, 2, and 3, seat pad 12 includes a top layer 30 and a bottom layer 32 that are joined together around their perimeters by way of a seam 34. Seam 34 may be formed by stitching or heat sealing top and bottom layers 30, 32 together or by securing them to each other by any other suitable means. Top and bottom layers 30, 32 preferably are manufactured from a suitable durable material that is somewhat flexible so that it substantially assumes the curvature of the seat 16 upon which it is placed. Top layer 30 may be formed from or topped with a wool or soft padded material to provide a more comfortable surface for the rider to sit upon. A cavity 84 (FIG. 6) is defined between top and bottom layers 30, 32 and an intermediate layer 88 is disposed within cavity 84 and between top and bottom layers 30, 32. Top layer 30, intermediate layer 88 and bottom layer 32 preferably are disposed one above the other. In the first preferred embodiment of a seat pad in accordance with the invention, intermediate layer 88 is made of a thin material which is secured within cavity 84 to either one of the top and bottom layers 30, 32. Preferably, intermediate layer 88 is adhesively secured to bottom layer 32.

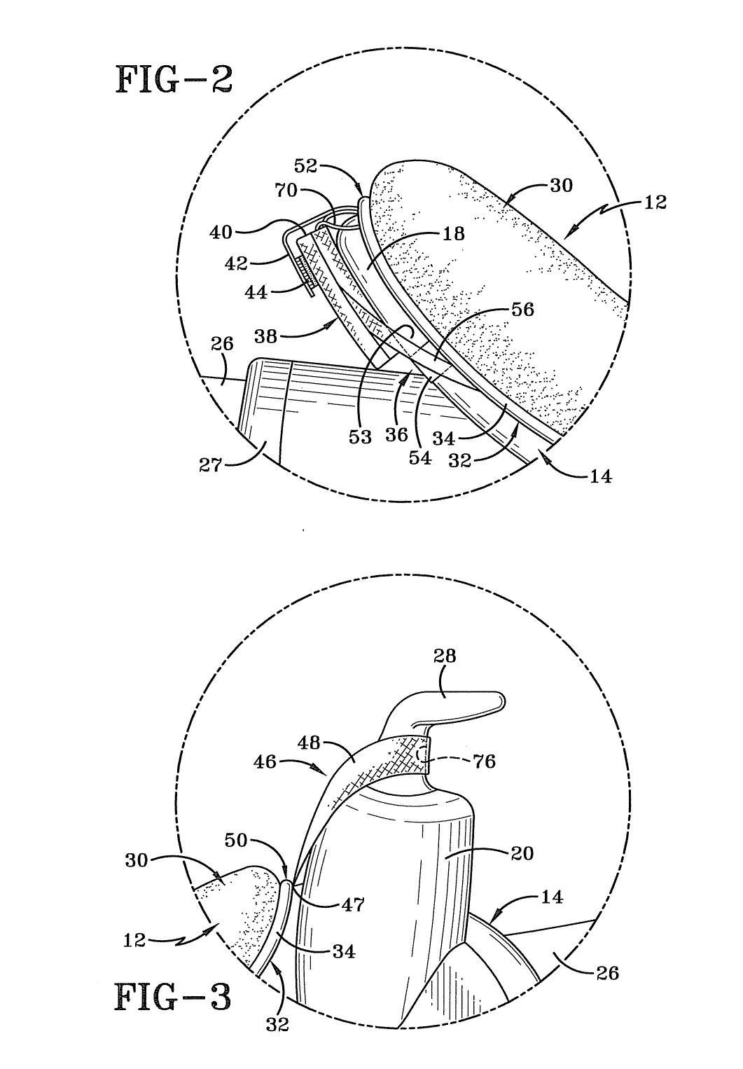

FIG. 1 shows that seat pad 12 is placed on seat 16 of saddle 14 in such a way that a front end 50 of seat pad 12 is positioned proximate pommel 20 of saddle 14, and a back end 52 of seat pad 12 is positioned proximate cantle 18 of saddle 14. FIG. 2 illustrates an enlarged view of back end 52 of seat pad 12 in conjunction with the back end of saddle 14, and more specifically with cantle 18 thereof. In accordance with a specific feature of the present invention, back end 52 of seat pad 12 is provided with a first attachment system 36 that is used to secure back end 52 to of seat pad 12 to the back end of saddle. In accordance with yet another specific feature of the present invention, front end 50 of seat pad 12 is provided with a second attachment system 46 that is used to secure front end 50 to the front end of saddle 14. First and second attachment systems 36, 46 gripping engage saddle 14 and thereby retain seat pad 12 with sufficient security on saddle 14 that the rider will not slide off the saddle on the seat pad.

First attachment system 36 is shown partially in FIG. 2 and is shown in greater detail in FIG. 4. In accordance with one of the specific features of the invention, first attachment system 36 includes at least one strap for securing seat pad 12 to saddle. Specifically, first attachment system 36 includes a horizontal strap 54, a left diagonal strap 56 and a right diagonal strap 58. A first end 60 of horizontal strap 54 is stitched or otherwise secured to seam 34 on one side of seat pad 12. A second end 60 of horizontal strap is stitched to seam 34 on the opposing side of seat pad 12. Similarly, an outer end 62 of each of the left and right diagonal straps 56, 58 is stitched to seam 34 on one of the sides of seat pad 12. An inner end 64 of each of the left and right diagonal straps 56, 58 is secured to a battery pouch 38 by stitching 66. Each of the straps 54, 56, 58 preferably is manufactured from an elastic material that allows the straps to be expanded outwardly away from bottom layer 32, thereby creating an expandable gap 53 (FIG. 2) between the straps 54-58 and bottom layer 32. Cantle 18 is received within gap 53, as will be hereinafter described.

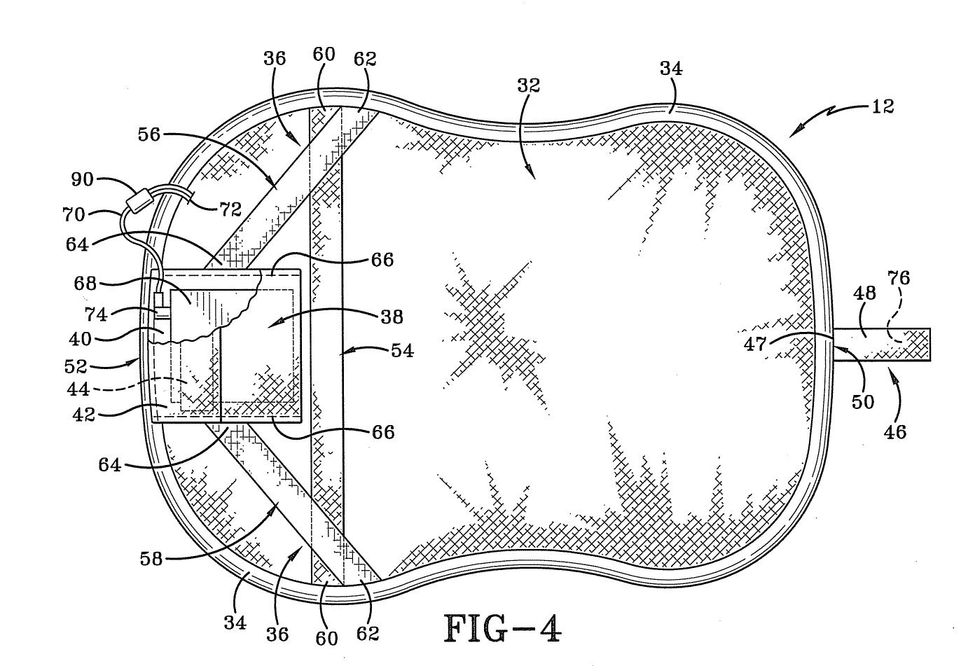

Referring to FIGS. 3 and 4, second attachment system 46 is secured to a front end 50 of seat pad 12. Second attachment 46 includes a strap 48 that has both of its first and second ends 47 secured to seam 34, preferably by stitching. As is evident from FIG. 4, the ends 47 of strap 48 as secured in generally the same location as each other to seam. Strap 48 preferably is made from an elastic material and is formed into a loop that defines a hole 76 (FIG. 6) therein. Elastic strap 48 may be extended outwardly to expand hole 76 in order to hook strap 48 over either horn 28 of saddle 14 or the pommel 20 thereof. When strap 48 is engaged with horn 28, front end 50 of seat pad 12 is retained on saddle 14.

In accordance with yet another feature of the present invention, seat pad 12 is provided with a power source to power one or more thermal pads 78, 80, 82 (FIGS. 1 & 6) retained within cavity 84 of seat pad 12. Preferably, the power source is a battery pack 68 (FIG. 4). Seat pad 12 is provided with a battery pouch 38 that is secured to seat pad 12, preferably to seam 34 and is disposed adjacent bottom layer 32. Battery pouch 38 is positioned in a location that places it on the opposite side of cantle 18 from seat pad 12 when first attachment system 36 engages seat pad 12 on cantle 18. Battery pouch 38 comprises a pocket having a cavity 40 in which battery pack 68 is retained. Pouch 38 includes a cover flap 42 that is securable by any appropriate means, such as a hook and loop fastener 44, to retain battery pack 68 securely within cavity 40. A wiring assembly 70 operationally connects battery pack 68 to first, second and third thermal pads 78, 80, 82 via a plug adapter 74. Although not illustrated in the figures, it will be understood that battery pack 68 further includes a switch for activating and deactivating the pack 68 and a thermostat for regulating the temperature settings of the thermal pads 78, 80, 82. Both the switch and the thermostat are accessed by opening flap 42 on battery pouch 38. Battery pack 68 is preferably a lithium ion or similar battery pack which is rechargeable and provides energy for a substantial amount of time for heating or cooling the first, second and third thermal pads 78, 80, and 82. In the preferred embodiment, an LPB-744B lithium ion battery pack is utilized providing voltage at 7.4 volts and 4400 mAh. Further, battery pack 68 is preferably of a compact size to fit within the constraints of seat pad 12 as well as providing adjustability in the temperature of the thermal pads.

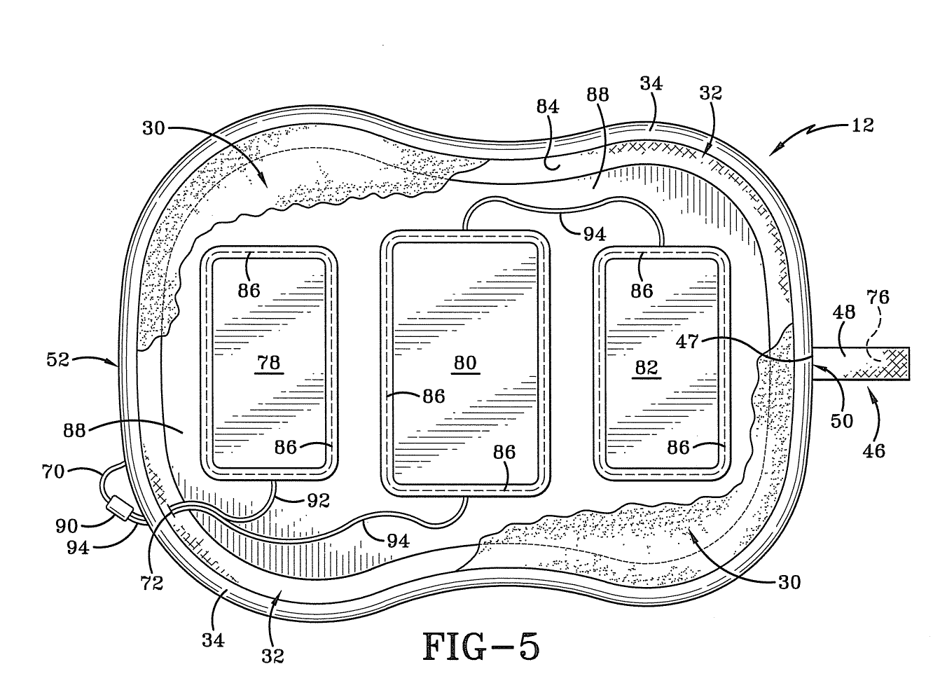

FIG. 5 illustrates a top view of seat pad 12 with portions of top layer 30 thereof removed. In accordance with another specific feature of the present invention, the first, second and third thermal pads 78, 80, 82 are arranged within cavity 84 of seat pad 12. Since intermediate layer 88 preferably is adhesively secured to bottom layer 32, there is a great deal of flexibility in the placement of first, second and third thermal pads 78, 80, 82. It will be understood that any number of thermal pads may be utilized in seat pad 12 without departing from the spirit and scope of the invention. Specifically, although three thermal pads are shown, a single large thermal pad could be utilized, or a plurality of very small pads could also be used without departing from the spirit and scope of the invention. In accordance with a specific feature of the present invention, first thermal pad 78, second thermal pad 80 and third thermal pad 82 are secured by stitching 86 to intermediate layer 88. Although the thermal pads 78, 80 and 82 are sewn into intermediate layer 88, it is within the spirit and scope of the present invention to secure them within cavity 84 by any suitable method of attachment including using an adhesive to glue them to intermediate layer 88 or by utilizing pockets formed in intermediate layer 88. Each of the thermal pads includes electrical components and thermal components that will allow the pad to be either heated or cooled upon activation of the battery pack 68. The exact internal structure of the first, second, and third thermal pads does not form part of the present invention. Any one of a variety of known electrically-operable thermal pads may be used in seat pad 12.

Wiring assembly 70 is connected to battery pack 68 as previously described and through an opening 72 (FIGS. 4 & 5) into cavity 84. Wiring assembly 70 is split at a junction box 90 into a first thermal wire 92 and a second thermal wire 94. First thermal wire 92 extends into first thermal pad 78 and provides electrical communication between first thermal pad 78 and battery pack 68. Second thermal wire 94 is secured to both of second and third thermal pads 80, 82 and provides electrical communication between battery pack 68 and thermal pads 80, 82. As is evident from FIG. 5, in seat pad 12, first thermal pad 78 is connected in parallel with second and third thermal pads 80 and 82. Furthermore, second and third thermal pads 80, 82 are connected in series with each other. First thermal pad 78 is therefore independently operable from second and third thermal pads 80, 82. It will be understood, however, that any suitable wiring arrangement which provides selectable heating or cooling energy to the rider during usage is acceptable. Each of first, second and third thermal pads 78, 80 and 82 is preferably arranged to heat or cool top layer 30 by resistance to the output to battery pack 68. FIG. 6 shows that first and second thermal wires 92, 94 generally run the length of seat pad 12 and preferably are disposed on the top side of intermediate layer 88.

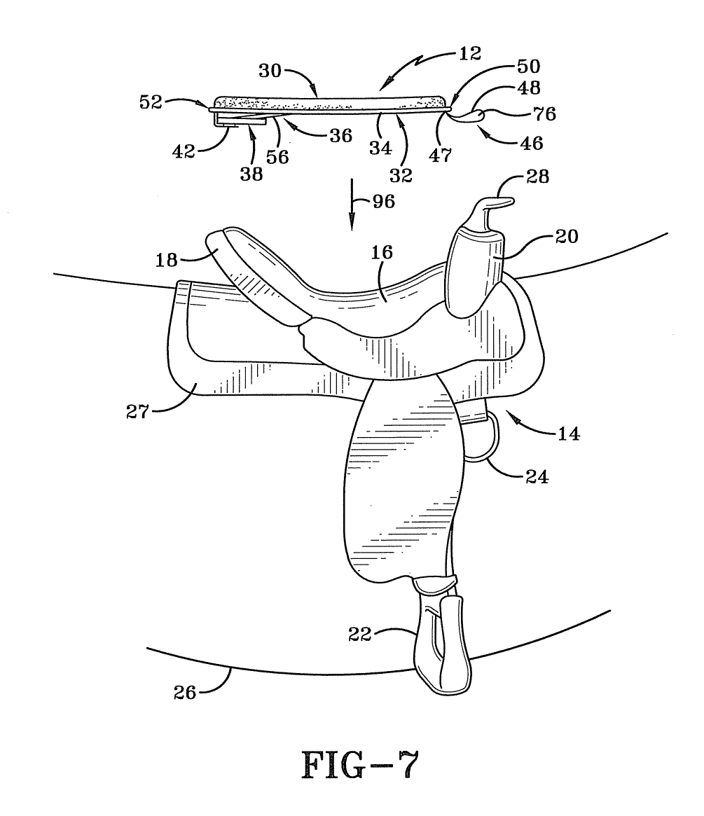

Having described the structure of the seat pad 12, a preferred method of operation will be described in greater detail and should be viewed in light of FIGS. 1 through 7 and particularly FIG. 7. FIG. 7 illustrates seat pad 12 being lowered onto saddle 14 and particularly onto a top surface of seat 16 thereof. First attachment system 36 and particularly horizontal strap 54, left diagonal strap 56 and right diagonal strap 58 are stretched outwardly away from bottom layer 32 to provide an opening for receiving cantle 18 therein. Initially, seat pad 12 is lowered in the direction associated with arrow 96 with the first attachment system 36 being expanded outwardly away from bottom layer 32 until the back end 52 of seat pad 12 is positioned proximate cantle 18. Straps 54, 56 and 58 are manipulated cantle 18 enters the gap 53 between straps 54, 56, 58 and bottom layer 32. Once this is accomplished, the rider releases straps 54, 56, 58 and attends to securing second attachment system 46 to the front end of saddle 14, and specifically to pommel 20. In the case of the Western saddle illustrated in FIG. 7, second attachment system 46 is specifically secured to horn 28 on pommel 20. In order to install second attachment system 46, the rider stretches strap 48 outwardly to increase the size of hole 76 defined thereby, and then encircles horn 28 with strap 48. The seat pad 12 may be shifted slightly so as to ensure that it is centered on seat 16 and that first and second attachment systems 36, 46 are securely seated around cantle 18 and horn 28.

Battery pack 68 may be inserted into battery pouch 38 before seat pad 12 is secured to saddle 14 or after seat pad 12 is secured to saddle. Either way, when the rider is ready to ride the horse 26, they turn on battery pack 68 by depressing the switch (not shown) and then manipulate the thermostat (not shown) to select and set the temperature level desired in seat pad 12. One or more of first, second and third thermal pads 78, 80, 82 are either heated or cooled to the temperature selected by the rider. It will be understood that the temperature of thermal pads 78, 80, 82 can be adjusted by the rider at any time, even while seated on seat pad 12, by opening flap 42 any making the desired changes to the thermostat or by switching the pack 68 on or off. The temperature generated in first, second and third thermal pads 78, 80, 82 is transferred by convection through to top layer 30 of seat pad 12 and thereby to the rider.

Having described the structure and operation of the first preferred embodiment, only those portions of the second preferred embodiment differ from those of the first embodiment are now described in greater detail. Similar reference characters refer to similar parts throughout the various embodiments.

FIGS. 8 and 9 illustrate a second preferred embodiment of a seating pad in accordance with the present invention. This second preferred embodiment is identified by the reference character 98. The majority of the components of seating pad 98 are substantially identical to those of seating pad 12 and seating pad 98 is secured to saddle 14 and is used in substantially the same manner as seating pad 12. Seating pad 98 differs from seating pad 12 in that the intermediate layer 100 provided in seating pad 98 is substantially thicker than intermediate layer 88 provided in seating pad 12. Intermediate layer 100 includes a top surface 102 and a plurality of apertures 104, 106, 108 which extend from top surface 102 through to the bottom surface thereof. Apertures 104, 106, 108 therefore extend through the entire thickness of intermediate layer 100 and provide an avenue for directing first and second thermal wires 92, 94 away from top layer 30 and therefore away from the rider. First, second and third thermal pads 78, 80, 82 preferably are adhesively secured to intermediate layer 100 although any other suitable attachment means is within the spirit and scope of the invention. The additional thickness of intermediate layer 100 makes seating pad 98 more cushioned than seating pad 12 and therefore adds to the comfort of the rider. Having first and second thermal wires 92, 94 directed through apertures 104, 106, 108 and away from the rider also adds to the overall safety of seating pad 98 and reduces the possibility that the thermal wires will deteriorate from being by being sat on periodically. The use of intermediate layer 100 may, therefore, extend the life of seating pad 98.

FIGS. 10, 11 and 12 illustrate a third preferred embodiment of the climate controlled seat pad, generally indicated at 112. Having described the structure of the second preferred embodiment, only those portions of the third preferred embodiment that differ from either of the first and second preferred embodiments, are described herein in greater detail. Again, similar reference characters refer to similar parts throughout the various embodiments. In accordance with still another aspect of the invention seat pad 112 includes a zipper 110 that traverses substantially the entire length of seat pad 112 from front end 50 to back end 52. Zipper 110 allows the rider access to internal cavity 84 of seat pad 112. Seat pad 112 includes first, second and third thermal pads 114, 116,118 arranged more or less evenly on intermediate layer 88. First, second and third thermal pads 114, 116, 118 are secured to intermediate layer 88 by a removable device such as a hook and loop fastener 120. Although the thermal pads 114, 116, 118 are shown engaged with intermediate layer 88, it is within the spirit and scope of the present invention to utilized intermediate layer 100 instead to provide a softer seating surface for the rider.

Seat pad 112, as illustrated, is not provided with a battery pouch 38 and a battery pack 68 and there are no first and second thermal wires 92, 94 extending between the first, second and third thermal pads 114, 116, 118. Instead, thermal pads 114, 116, 118 are removable pouches that are filled with a thermal material such as a gel or other heatable or freezable substance that may be heated in a microwave, for example, or cooled in a freezer. Additionally, top layer 30 may include a plurality of perforations (not shown) to allow the thermal flow from thermal pads 114, 116, 118 to more easily reach the rider.

In operation, the rider opens zipper 110 to access cavity 84. First, second and third thermal pads 114, 116, 118 may be heated in a microwave or cooled in a freezer. The heated or cooled pads 114, 116, 118 are then inserted into cavity 84 and secured to intermediate layer by way of hook and loop fasteners 120, for example. The rider then closes zipper 110 to seal cavity 84 and then engages seat pad 112 with saddle 14 in substantially the same manner as indicated with reference to seat pad 12. The rider then seats themselves upon the seat pad 112. When the temperature of first, second and third thermal pads 114, 116, 118 becomes substantially the same as the ambient temperature, the rider may dismount, disengage at least one of the first and second attachment systems 36, 46, open zipper 110, remove the first, second and third thermal pads 114, 116, 118 and replace them with newly heated or cooled thermal pads. The removed one of the first and second attachment systems 36, 46 is then reengaged and the rider is able to mount the horse once again.

FIGS. 13 and 14 illustrate fourth and fifth preferred embodiments of a seat pad in accordance with the present invention, and generally indicated as seat pads 122 and 124, respectively. Having described the structure and operation of the first three embodiments, only those portions of the fourth and fifth embodiment which differ from the first three embodiments are now described in detail. Once again, similar reference characters refer to similar parts throughout the various embodiments. Seat pads 122 and 124 are each adapted to be secured to an English style saddle, i.e., to a saddle that does not posses a horn 28. Accordingly, the second attachment system 46 provided on the first three embodiments of the invention is replaced with an alternative second attachment system, This alternative second attachment system is identified by the reference character 126 in seat pad 122 and by 128 in seat pad 124.

Second attachment system 126 used on seat pad 122 (FIG. 13) includes a first strap 130 having an outer end 132 and an inner end 134. Outer end 132 is secure in a location along front end 50 of seat pad 122 and inner end 134 is disposed a distance inwardly therefrom. Outer end 132 is secured at seam 34 by any suitable means such as stitching, while second end 134 thereof includes a male snap connector 142. Second attachment system 126 also includes a second strap 136 having an outer end 138 and an inner end 140. Outer end 138 of second strap 136 is stitched to battery pouch 38, while inner end 140 is disposed a distance inwardly therefrom and includes a female snap connector 144. Both of first and second straps 130,136 also include adjusters 146 for modifying the length of the second attachment system 126 based on the dimensions of saddle14.

In operation, the rider secures the back end 52 of seat pad 126 using first attachment system 36 ensuring that second strap 136 extends forwardly toward front end 52 of seat pad. The rider then passes first strap 130 around the front end of the saddle and then rearwardly beneath the bottom surface of saddle 14 and toward back end 52 of seat pad 126. The front end 50 of seat pad 126 is lowered and male snap connector 142 is engaged with female snap connector 144 to secure first and second straps 130, 136 together. The adjusters 146 on both the first and second straps 130, 136 permit precise adjustment of the second attachment system 126 so that seat pad 122 is snugly retained on the seat 16 of saddle 14.

FIG. 13 shows that the same type of thermal pad and battery pack system used in conjunction with seat pad 12 is provided on seat pad 122. Thus, the rider controls the temperature of seat pad 122 in the same manner as seat pad 12.

As seen in FIG. 14, seat pad 124 includes a different type of first attachment system 152. The first attachment system 152 comprises a cloth section 153 which is secured on three sides of its perimeter to seam 34 proximate back end 52 of seat pad 124. Cloth section 153 has a front edge 160 which defines an opening to an interior gap (not shown) between an interior surface of cloth section 153 and bottom layer 32 of seat pad 124. The cantle 18 of the saddle is received in this gap between cloth section 153 and bottom layer 32. Preferably, the fabric used for cloth section 153 is elastic in nature and is therefore expandable to receive cantle 18 therein.

The second attachment system 128 is designed to engage the front end of the saddle and includes a first, second and third straps 148, 162, 172 and a connection region 150. The connection region is secured either to an exterior surface of cloth section 153 or, if provided, to battery pouch 38. Connection region 150 is provided with one of a hook and loop fastener on its exterior surface. First strap 148 has an outer end 149 secured at a first location on front end 50. An interior surface 154 of first strap 148 is provided with a strip 156 of the other of the hook and loop fastener which is selectively matingly engageable with connection region 150. Second strap 162 is secured at its outer end 163 to seam 34 and has an interior surface 164 with a strip 166 of the other of the hook and loop fastener thereon which is also selectively engageable with connection region 150. Third strap 172 is secured at its outer end 173 to seam 34 and has an interior surface 174 with a strip 176 of the other of the hook and loop fastener thereon which is also selectively engageable with connection region 150. Connection region 150 is larger in area than the portions of first, second and third straps 148, 162,172 that are engaged therewith. This difference in size makes it possible for the rider to adjust the positioning of the straps to achieve a snug fit of seat pad 124 on the saddle.

As with the previous embodiments, the back end 52 of seat pad 124 is engaged with saddle 14 before the front end 50 thereof. Thus, first attachment system 152 is engaged with cantle 18, then front end 50 of seat pad 124 is lowered toward saddle 14 and first, second and third straps 148, 162, 172 are passed over the front end of the saddle and then directed beneath the bottom surface of saddle 14 and toward the back end 52 of seat pad 124. The straps 148, 162, 172 are engaged with region 150 to secure seat pad 124 on saddle 14.

Although not specifically illustrated herein it will be understood by those skilled in the art that each of the fourth and fifth embodiments of the seat pad in accordance with the present invention, will include one or more of the previously disclosed thermal pads for heating or cooling of the top layer 30 of the seat pad.

It will further be understood, that a zipper may be provided on either of the first, second, fourth and fifth embodiments to provide access into the cavity 84 of seat pad 12 or seat pad 98. Additional heating or cooling elements such as small fans or other devices controlled by a power source may also be incorporated therein to provide a thermal flow to top layer 30 of the respective seat pads without departing from the spirit and scope of the present invention.

Each one of the first, second, third, fourth and fifth embodiments of the seat pad in accordance with the present invention provides efficient and effective first and second attachment systems which allow a firm connection between the seat pad and the saddle. The saddle in question can be any one of a Western saddle, an English saddle or any other style of Stock saddle. Further, the seat pad in accordance with the present invention also includes a climate controlled device which is user operable to provide a comfortable and enjoyable ride in substantially any temperature conditions.

It will be evident to one skilled in the art that a variety of changes can be made that are in the spirit and scope of the present invention. For instance, the intermediate layer could easily be replaced with a thicker layer to provide greater support for either heated or cooled versions of the seat pad. Further, a number of attachment systems have been described and these are easily interchangeable with one another to provide the most appropriate securing method based on the type of saddle. Additionally, the various first attachment systems that have been disclosed as being removably engageable with the back end of the saddle could, instead, be removably engaged with the front end of the saddle; and the types of second attachment systems that have been disposed as being removably engageable with the front end of the saddle could, instead, be removably engaged with the back end of the saddle. Further, the method of installation is merely exemplary as the front end of the seat pad and second attachment system could be engaged with the saddle before the back end of the seat pad and the first attachment system.

It will also be understood that while the various components of the first and second attachment systems have been disclosed as being secured to the seam formed around the perimeter of the seat pad where the top and bottom layers thereof are secured together, one of ordinary skill in the art will realize that the ends of the straps, for example could, instead, be secured to the top layer or the bottom layer of the seat pad.

Accordingly, the climate controlled seat pad is an effective, safe, inexpensive, and efficient device that achieves substantially all the enumerated objectives of the invention, provides for substantially eliminating difficulties encountered with prior art devices, systems, and methods, and solves problems and obtains new results in the art.

In the foregoing description, certain terms have been used for brevity, clarity, and understanding. No unnecessary limitations are to be implied therefrom beyond the requirement of the prior art because such terms are used for descriptive purposes only and are intended to be broadly construed.

Moreover, the description and illustration of the invention are examples and the invention is not limited to the exact details as shown or described. Having now described the features discoveries, and principles of the invention, the manner in which the climate controlled seat pad is constructed and used, the characteristics of the construction, and the advantageous new and useful results obtained; the new and useful structures, devices, elements, arrangement, parts, and combinations are set forth in the appended claims.

1. A climate controlled seat pad for placement on an upper surface of a seat of a saddle; wherein the seat pad comprises:
a top layer;
a bottom layer, where the top and bottom layers are joined together around a perimeter;
a cavity defined between the top and bottom layers;
at least one thermal pad disposed in the cavity, wherein said thermal pad is positioned to alter the temperature of the top layer.

2. The seat pad as defined in claim 1, further comprising:
a first attachment system provided on the seat pad and adapted to be removably secured to the saddle.

3. The seat pad as defined in claim 2, wherein the first attachment system comprises:
a strap having a first end and a second end, where the first end is secured to the seat pad at a first location and the second end is secured to the seat pad at a second location;
a gap defined between the strap and the seat pad, and wherein the seat pad is adapted to receive a portion of the saddle in the gap.

4. The seat pad as defined in claim 3, wherein the first end of the strap is fixedly secured to the seat pad.

5. The seat pad as defined in claim 4, wherein the strap is made from an elastic material.

6. The seat pad as defined in claim 5, wherein the first and second locations are disposed proximate each other.

7. The seat pad as defined in claim 5, wherein the first and second locations are disposed a spaced distance apart from each other.

8. The seat pad as defined in claim 4, wherein the second end of the strap is fixedly secured to the seat pad.

9. The seat pad as defined in claim 4, wherein the second end of the strap is removably secured to the seat pad.

10. The seat pad as defined in claim 7, wherein the strap further includes: a securement device disposed thereon.

11. The seat pad as defined in claim 10, wherein the securement device on the strap comprises one of a hook and loop fastener; and wherein the seat pad further includes a region of the other of a hook and loop fastener positioned in a location where the region is engageable with the hook and loop fastener on the strap.

12. The seat pad as defined in claim 10, wherein the securement device comprises one of a male and a female connector; and wherein the seat pad further includes a second strap secured at a first end to the seat pad and having the other of a male and a female connector provided at a second end thereof; and wherein the male and female connectors are selectively connectable together.

13. The seat pad as defined in claim 12, further comprising at least one adjustment device provided on one of the strap and the second strap, and wherein the at least one adjustment device is provided to selectively alter a length of the one of the strap and the second strap.

14. The seat pad as defined in claim 2, further comprising:
a second attachment system provided on the seat pad and adapted to be removably secured to the saddle; and wherein the first attachment system is adapted to be secured to one of the front and back ends of the saddle and the second attachment system is adapted to be secured to the other of the front and back ends of the saddle.

15. The seat pad as defined in claim 2, wherein the first attachment system comprises a length of fabric that is secured partially around its perimeter to an area of the seat pad, and wherein a gap is defined between the fabric and a portion of the seat pad, and wherein a region of the saddle is receivable in the gap.

16. The seat pad as defined in claim 1, further comprising an intermediate layer disposed in the cavity between the top and bottom layers; and wherein the at least one thermal pad is one of permanently secured and releasably secured to the intermediate layer.

17. The seat pad as defined in claim 1, further comprising:
a power source;
at least one wire connecting the power source to the thermal pad and wherein the power source is activated to change the temperature of the thermal pad.

18. The seat pad as defined in claim 17, wherein the power source is activated to one of heat and cool the thermal pad.

19. The seat pad as defined in claim 1, wherein the at least one thermal pad is removable from the cavity of the seat pad and is adapted to be one of heated and cooled in a remote location relative to the seat pad.

20. In combination,
a saddle including a seat having an upper surface, a lower surface, a front end and a back end; and
a climate controlled seat pad for placement on the upper surface of the seat; wherein the seat pad comprises:
a top layer;
a bottom layer, where the top and bottom layers are joined together around a perimeter; and the bottom layer is positionable in abutting contact with the upper surface of the seat;
a cavity defined between the top and bottom layers;
at least one thermal pad disposed in the cavity, wherein said thermal pad is activatable to alter the temperature of the top layer; and
a first attachment system for removably securing the seat pad to the saddle.

21. The combination as defined in claim 20, further comprising a second attachment system for removably securing the seat pad to the saddle; wherein the first attachment system is releasably securable to a back end of the saddle and the second attachment system is releasably securably to a front end of the saddle.
